(19) United States
(12) Patent Application Publication
(10) Pub. No.: US 2005/0163560 A1
(43) Pub. Date: Jul. 28, 2005

(54) Hinge system, particularly for devices used in robotics and for spectacle frames

(76) Inventors: Richard Chene, Neuilly sur Seine (FR); Dominique Delamour, Les Mesnuls (FR); Olivier Rodi, Gambais (FR)

Correspondence Address: YOUNG & THOMPSON, 745 SOUTH 23RD STREET, 2ND FLOOR, ARLINGTON, VA, 22202, US

(21) Appl. No.: 10/509,994

(22) PCT Filed: Jan. 22, 2004
(86) PCT No.: PCT/FR04/00135

(30) Foreign Application Priority Data
Jan. 22, 2003 (FR) 0300642

(51) Int. Cl. F16D 1/00

(52) U.S. Cl. 403/229

(57) ABSTRACT

The invention relates to a hinge system comprising one end (1) belonging to a first rigid element (7) and one end (3) belonging to a second rigid element (8), said ends having support surfaces which can be matched to one another. According to the invention, elastic means (18) are provided in order to maintain the pressure contact between the aforementioned surfaces. The inventive system also comprises at least one immaterial pivot point which can move in two orthogonal planes within the limits allowed by guide means (6) and means (19a-b) which only authorise pivoting in one plane or in a certain number of planes having a determined orientation.

The subject of the present invention is a system of articulation, especially for equipment used in robotics and for spectacle frames.

More precisely, the invention relates to a system of articulation between one end of a first rigid element and one end of a second rigid element, of the type in which said ends have bearing surfaces fit for pairing up respectively one on top of the other, elastic means being provided to maintain the bearing contact between said surfaces.

The majority of the equipment used in robotics (walking robots, modular robots, manufacturing robotics, medical robotics, micro-robotics, etc.) is provided with articulations which allow pivoting over a continuous angular range and, often, in a multiplicity of planes. Such articulations allow the equipment to perform a wide variety of actions and displacements in the reachable space. However, the mechanisms of these articulations are, by nature, unstable or monostable in the rest position and it follows that this equipment permanently calls upon its actuating gear (for example, an actuating cylinder) to hold it in a chosen position, as soon as its rest position is no longer pertinent.

Now, pivoting over a range may neither be necessary, nor even desirable.

Thus, in medical robotics, use over a continuous range of variable-pointing optics is of no real interest to surgeons. Similarly, the deflections of polyarticulated endoscopes, such as they are used in practice, border on the “all or nothing”.

In manufacturing robotics, moreover, the continuity of the range of pivoting impairs, in the long run, positioning accuracy and repetitivity.

As far as walking robots are concerned, they do not necessarily require legs with a continuous reachable space.

In brief, a concept of discrete articulation would reduce costs, limit the stress upon the actuating gear or gears and, in the case of manufacturing robotics, guarantee positioning accuracy over time.

In the field of spectacles manufacture and others (vehicle doors, furniture leaves, for example), use is sometimes made of so-called “elastic” hinges, suitable for holding the moving part in one or two stable positions, such as the closed and open positions of a spectacle side-piece, for example.

These “elastic” hinges are provided, for the most part, with a rotation axis which limits the displacement of the moving part to a displacement in a given plane.

From EP-A-0 886 712, spectacle hinges are also known, the moving and fixed parts of which are connected by an elastic link, by which the moving part can travel in any plane whatsoever, between fixed limits, and can even pivot upon itself: although these hinges are undoubtedly appealing, they are complicated to produce and to miniaturize and their relative fragility is severely tested by their users, who have a tendency to play with the side-pieces. These hinges are not suitable for keeping to a plurality of stable positions in a plurality of planes and/or for being provided with an actuating device which would allow passage from one stable position to another.

From U.S. Pat. No. 4,785,528, an articulated gantry is also known, which can be manipulated by a robot. The system of articulation is designed such that the end of the gantry moves as freely as possible and such that this end can pivot upon itself.

The object of the present invention is to provide an articulation capable of allowing two rigid elements (fixed and moving, respectively) to occupy various stable and/or unstable, precisely determined, relative angular positions, that end of the moving element which is opposite to the articulation traveling along repetitive linear trajectories without it being necessary to call upon any actuating device with which the articulation might be provided.

This object is achieved in this sense that the system of articulation of the aforesaid type comprises at least one intangible pivot point movable in two orthogonal planes within the limits permitted it by guide means and means which allow pivoting only in one or some planes, the number and orientation of which are defined.

In one particular embodiment of the invention, the articulation comprises two such intangible pivot points situated on two different and substantially orthogonal planes.

More precisely, the system of articulation comprises two pivot parts, each having a recessed zone limited by an at least partially curved surface, each of said pivot parts depending respectively on one of said rigid elements, said pivot parts being substantially orthogonal to each other, and engaged one in the other through interlocking of their respective recessed zone, such as to be able to pivot relative to each other in the manner of the links of a chain.

In practice, the pivot parts may take, for example, the form of a ring, a loop, a hook or a polygonal plate, having a recess limited by an at least partially curved surface.

It is advantageous for one of the pivot parts to be closed (ring, loop, etc.) and for the other to be open (hook), since that can facilitate assembly or disassembly, but solutions using two closed elements are equally possible.

The at least partially curved surface limiting the recessed zone of each of the pivot parts will most often be circular. However, in certain applications in which it is wished to subject the pivoting to a cam effect, this surface may be elliptical, or of any other curved shape, including an irregular shape.

It will be appreciated that the two intangible pivot points are separated by a distance corresponding substantially to the average of the thickness of the material of each of said pivot parts engaged one in the other and in “curved surface of recessed zone” against “curved surface of recessed zone” contact.

By playing upon this thickness, it is possible, therefore, to space the two pivot points further apart or closer together.

In one particular embodiment of the invention, one at least of the ends of said rigid elements incorporates a receptacle, open on the articulation side and provided with a tie rod, one end of which is held captive in said receptacle and the other end of which constitutes one of said pivot parts, said elastic means cooperating with said tie rod in order to force the bearing faces of said rigid elements to remain in contact one with the other.

The elastic means in question can be constituted by a helical spring, threaded on the tie rod and bearing, on the one hand, upon a shoulder, which is provided in the receptacle and provides a passage through which slides the tie rod, and, on the other hand, upon an end plate, which is larger in section than said passage, and holds the tie rod captive in said receptacle.

The system may contain a spring-loaded tie rod of this type in one only of the rigid elements or in both. When it contains just one thereof, sufficient play must be provided between the two pivot parts to enable them to perform their function.

In order to determine the orientation and/or the number of plane(s) allowed for the pivoting, one at least of the ends of said rigid elements incorporates a receptacle, open on the articulation side, and the wall of said receptacle has at least one axial notch, the geometry and size of which allow a pivot part portion to penetrate into said notch from the open end of said receptacle.

In a first possible embodiment, only a single notch is provided.

In a second possible embodiment, two notches are provided in the same plane, on the opposite walls of the receptacle.

The number and the relative position of the notches is chosen as a function of the number of wanted stable positions and their orientation.

Preferably, said guide elements which channel the displacements of the moving element prevent said moving element from pivoting upon itself, at least as long as it is not occupying a stable position.

To this end, an anti-rotation relief may be provided on one of the pivot parts and this anti-rotation relief can constitute the pivot part portion capable of penetrating into the notch(es).

In order to facilitate this penetration, the wall of the receptacle advantageously has access ramps to said notch(es) from the outside of the rigid element.

In another embodiment, on the outer face of the wall of the receptacle and opposite the open end of the latter, said notch(es) open out into a concave (or convex) surface of revolution and the end of the other rigid element comprises a convex (or concave) surface of revolution of complementary size and shape, whereby one of the elements can be rotated about its longitudinal axis relative to the other whilst they are in stable angular position.

In order to jam the articulation in a stable position, the bearing faces of the two rigid elements advantageously have at least one pair of complementary reliefs suitable for engaging in a selected relative angular position.

In one particular application of the invention, said rigid elements are respectively a spectacle side-piece and face.

In one particular embodiment of the invention, one at least of the rigid elements comprises, at its end opposite to the articulation, a joining means capable of engaging temporarily with a complementary joining means provided on another element. It is thus possible to realize an articulated train for use in robotics.

The invention will now be described in greater detail with reference to the appended drawings, in which:

FIG. 1 illustrates diagrammatically the principle on which the invention is based;

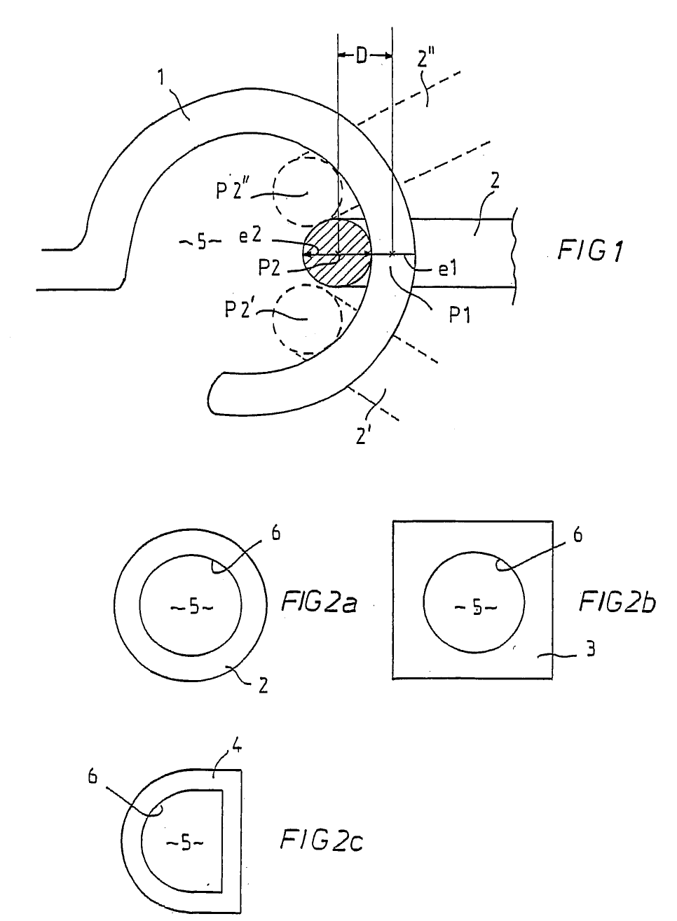

FIGS. 2a, 2b and 2c illustrate possible forms for the pivot parts;

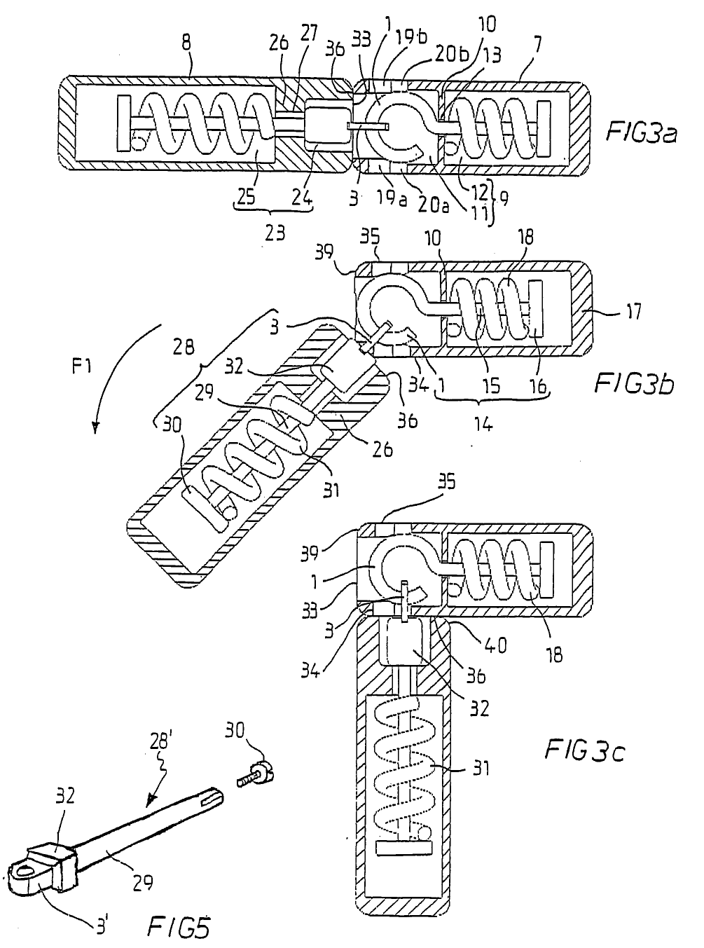

FIGS. 3a, 3b and 3c are views, partially in section, partially in perspective, of a first embodiment of the invention, respectively in a first stable position, in an unstable position and in a second stable position;

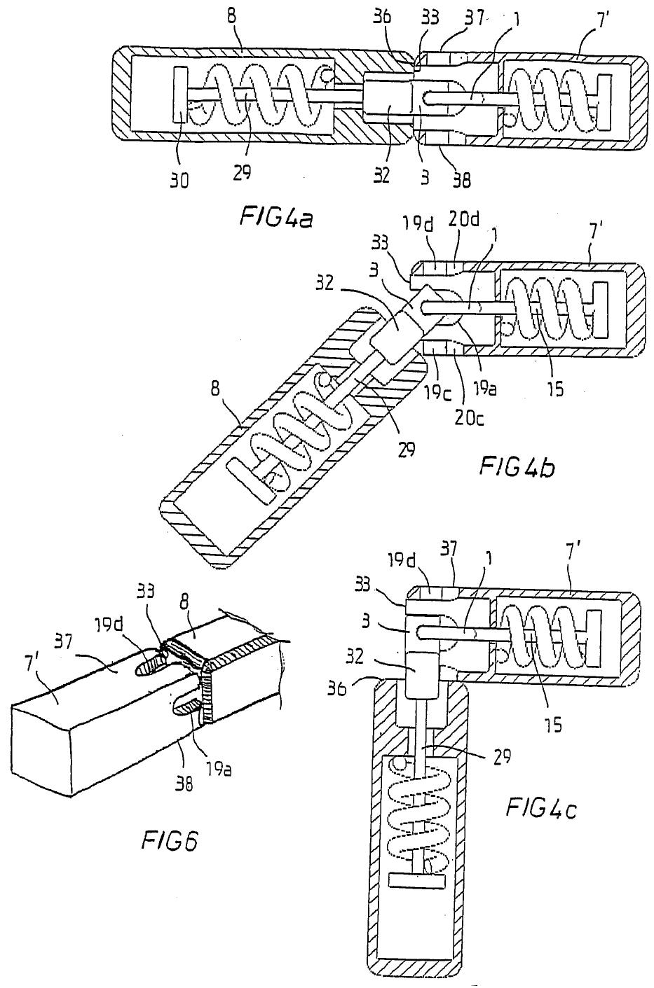

FIGS. 4a, 4b and 4c are views, partially in section, partially in perspective, of a second embodiment of the invention, respectively in a first stable position, in an unstable position and in a second stable position;

FIG. 5 is an exploded perspective view of an example of a tie rod;

FIG. 6 is a perspective view of the ends of the rigid elements of the embodiment of FIGS. 4a-4c;

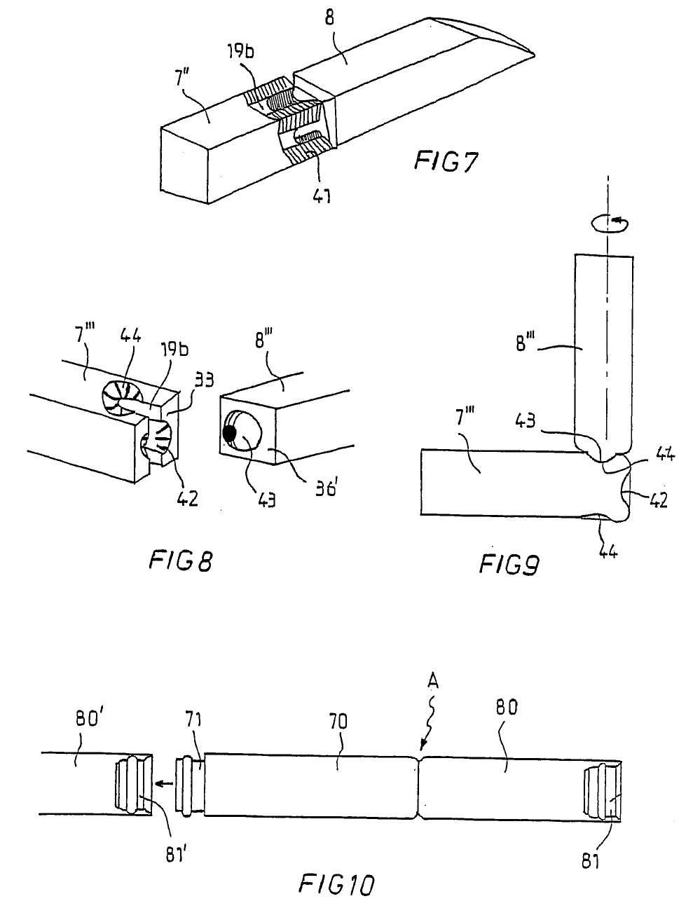

FIG. 7 is a view similar to FIG. 6, showing a variant;

FIG. 8 is a perspective view of the ends of the rigid elements showing another variant, the elements being in the disassembled state;

FIG. 9 shows the elements of FIG. 8, in the assembled state; and

FIG. 10 is a perspective view of an articulated “train” making use of the invention.

FIG. 1 illustrates diagrammatically the principle on which the invention is based.

In this figure can be seen a hook 1 slipped into a ring 2, one situated in the plane of the drawing sheet, the other in a plane orthogonal to said sheet.

The ring 2 can pivot on the hook 1 about the point P2, with the point P2 remaining in the plane of the drawing sheet. In so doing, the ring 2 passes, for example, into the position 2′ or 2″, with the point P2 ending up, respectively, at P2′ and P2″. The displacement of the ring 2 is “channeled” by the inner curvature of the hook 1 for as long as the ring 2 is held pressed against the hook 1. With an identical result, the hook 1 can pivot on the ring 2, about the point P1, with the point P1 remaining in the plane of the drawing sheet.

In addition, the ring 2 can also pivot on the hook 1 in a whole series of planes orthogonal to the plane of the drawing sheet and passing through the various possible positions previously occupied by the point P2, such as P2′ and P2″, the displacement of the hook 1 being channeled by the inner curvature d of the ring 2 for as long as the hook 1 is held pressed against the ring 2.

P1 and P2 are therefore movable within the limits allowed respectively by the guide means constituted by the inner curvature of the link 2 and that of the hook 1 and they are separated by a distance D equal to the average of the thickness e1 of the hook 1 in the contact zone and the thickness e2 of the ring 2 in this same zone.

FIGS. 2a, 2b and 2c illustrate diagrammatically possible and non-limiting embodiments of the pivot parts: in the form of a toric ring 2, a polygonal (square) plate 3 having an opening, an inverted D 4. The pivot part may equally take the form of a hook 1, as in FIG. 1. What matters is that the part has a recess 5 bordered at least in part by a curved surface 6, a recess which may be circular (FIGS. 2a and 2b), partially circular (FIGS. 1 and 2c) or non-circular.

FIGS. 3a, 3b and 3c illustrate respectively a first stable position, an unstable position and a second stable position of a first embodiment of the invention, observed in the plane of the hook 1.

As is apparent from FIGS. 3a-c, the system of articulation is mounted partially in a first rigid, so-called “fixed”, element 7, and partially in a second rigid, so-called “moving”, element 8. It is obvious that this distinction between “moving” element and “fixed” element can be artificial insofar as, in certain situations, each of the elements may be regarded as “moving” relative to the other.

The fixed element 7 defines a receptacle 9 divided by a partition 10 into a proximal portion 11 (proximal relative to the articulation) and a distal portion 12. A passage 13 is provided in the partition 10 for a tie rod 14. The tie rod 14 is composed of a rod 15, the proximal end of which forms the hook 1 and the distal end of which is provided with a stop 16. This stop 16 can be the head of a screw screwed in the rod 15, a passage (not represented) being provided in the bottom 17 of the receptacle 9 for the introduction of this screw and the end of a screwdriver. A helical spring 18 is threaded on the rod 15 and bears, on the one hand, upon the stop 16 and, on the other hand, upon the partition 10. The wall of the proximal portion 11 of the receptacle 9 has two notches 19a and 19b situated in the plane of the hook 1, each of which leads into a ramp 20a and 20b.

The moving element 8 similarly comprises a receptacle 23 divided into a proximal portion 24 and a distal portion 25 by a partition 26, in which a passage 27 for a tie rod 28 is provided. The tie rod 28 is composed of a rod 29, the proximal end of which is fixedly joined to a parallelepipedal block 32, forming an anti-rotation member, of dimensions substantially close to that of the proximal portion 24 of the receptacle 23 and extending through a square plate 3 having a circular bore. For the sake of simplicity, the square plate in question will hereinafter be referred to as the link 3. The distal end of the rod 29 is provided with a stop 30, which, like the stop 16, may be a screw head. A helical spring 31 is threaded on the rod 29 and bears, on one hand, upon the stop 30 and, on the other hand, upon the partition 26.

The proximal end of the fixed element 7 has three bearing faces 33, 34 and 35 and the proximal end of the moving element 8 has a bearing face 36. The edges 39 and 40 of the proximal end of the fixed and moving elements 7 and 8 are rounded to facilitate the relative movement between the two elements.

The tension of the springs is chosen such that, in stable position, the spring 18 holds the hook 1 set back from the bearing face 33 and that the spring 31 holds the block 32 in such a way that its proximal face lies flush with the bearing face 36.

As is apparent from FIGS. 3a-c, the hook 1 is threaded in the link 3.

In FIG. 3a, the unit occupies a first stable position in which the fixed elements 7 and moving elements 8 are in mutual alignment, the bearing face 36 of the moving element 8 being pressed against the bearing face 33 of the fixed element. In this position, the hook 1 is set back from the bearing face 33 and the link 3 is received in the proximal portion 11 of the receptacle 9 of the fixed element 7.

In FIG. 3b, the moving element 8 has been “dislocated” relative to the position which it occupied in FIG. 3a so as to be able to pivot according to the arrow F1. This dislocation is made possible by a traction exerted by the link 3 upon the hook 1, counter to the force of the springs 18 and 31, which find themselves thereby compressed. It can be seen that the hook 1 now lies flush with the bearing face 33 and that the block 32 projects slightly from the moving element 8. The pivoting is also made possible by the presence of the notch 19a, which allows the passage of the link 3 and of the block 32.

In FIG. 3c, the bearing face 36 of the moving element 8 is now pressed against the bearing face 34 of the fixed element 7. The hook 1 and the block 32 have regained their positions of FIG. 3a and the springs 18 and 31 have also reverted to their initial degree of tension. The link 3 is in contact with the ramp 20a with its non-visible edge, whereas its visible edge is in contact with another ramp (not visible), symmetrical to the ramp 20a.

It will be appreciated that, if the fixed element 7 were to comprise a second notch 19b opposite to the notch 19a, the moving element 8 could be brought into a third stable position, namely with its bearing face 36 pressed against the bearing face 35 of the fixed element 7.

A tie rod 28′, similar to the tie rod 28, is represented in isolation in FIG. 5. The rod 29, the anti-rotation block 32, a link 3′, slightly different than the link 3, and the screw head 30 can there be found.

FIGS. 4a, 4b and 4c illustrate respectively a first stable position, an unstable position and a second stable position of a second embodiment of the invention, observed, this time, in the plane of the link 3.

The embodiment of FIGS. 4a-c differs from that of FIGS. 3a-c by the fact that the fixed element 7′ comprises five bearing faces, namely an end bearing face 33 as in the previous embodiment, and four lateral bearing faces, only two of which 37 and 38 are visible in the figures. The two others are situated like the bearing faces 34 and 35 of the element 7. It follows that the rigid element 7′ comprises four notches, three of which are visible, 19a, 19c and 19d, notches which lead into ramps such as 20c and 20d.

The configuration of the fixed element 7′ is more clearly apparent from FIG. 6. There it can be seen that the fixed element 7′ comprises an end bearing face 33 and four lateral bearing faces, only two of which 37 and 38 are visible in the figure. The two other bearing faces are respectively opposite the faces 37 and 38. A notch, such as 19a, 19d, is provided in each lateral bearing face, the notches of two opposite faces being situated in the same plane. This embodiment therefore offers two deflection planes and five stable positions: elements 7′ and 8 aligned, or elements 7′ and 8 at 90°, in one of the four possible positions.

FIG. 7 illustrates a construction variant of the embodiment of FIG. 6, in which a fixed element 7″ and a moving element 8′ are found, but in which ramps, such as 41, are provided along the edges of the notches, such as 19b, to facilitate the penetration and guidance of the link 3 in said notches.

FIG. 8 illustrates another variant, in which the end bearing face 33 of the fixed element 7′″ has a concave relief 42 of size and geometry corresponding to those of a convex relief 43 provided on the bearing face 36′ of the moving element 8′″. Similarly, each notch, such as 19b, opens out into a concave relief 44 of size and geometry corresponding to those of the convex relief 43. As is apparent from FIG. 9, this arrangement allows the moving element 8′″ to rotate about its longitudinal axis, into any one of its stable positions. In this case, of course, the tie rod included in the element 8′″ is deprived of an anti-rotation block. Such an embodiment can be used, for example, in the production of an endoscope.

FIG. 10 illustrates one possible application of the invention, namely the realization of an articulated “train” of elements. The elements 70 and 80 are articulated at A according to the invention and one, such as 70, has a male thread 71, whereas the other, such as 80, has a female thread 81. The male thread 71 is capable of engaging with a female thread 81′ provided in another element 80′, similar to the element 80, or different in nature, for example a link to a camera, a transducer, etc. Such an articulated train of elements is capable of being used in medical robotics, for example.

It is obvious that the present invention is not limited to the embodiments which have been described and represented. In particular, although these embodiments show articulations capable of having, in addition to the stable aligned position, two or four stable angular (lateral) positions, they might only have one of them, for example in the application of the articulation to a spectacle frame.

Moreover, means can be provided which allow the force of the springs to be adjusted to prevent the bearing faces of the rigid elements from coming apart, the compression force of the springs being able to act as braking means so as to jam the articulation in the desired configuration.

In one particular embodiment, finally, it is possible to incorporate control devices, of position measurement and of information transmission, into a limited space in the body of one of the rigid elements, to allow the development of milli robots or micro robots.

1-15. (canceled)

16. A system of articulation comprising at least one pivot point between one end of a first rigid element and one end of a second rigid element, said ends having bearing faces fit for pairing up respectively one on top of the other, elastic means being provided to maintain the bearing contact between said faces, wherein said system comprises two pivot parts, each having a recessed zone limited by an at least partially curved surface, each of said pivot parts depending respectively on one of said rigid elements, said pivot parts being substantially orthogonal to each other, and engaged one in the other through interlocking of their respective recessed zone, such as to be able to pivot relative to each other in the manner of the links of a chain, with the result that said system comprises two intangible pivot points movable in the two orthogonal planes of said pivot parts within the limits permitted it by said recessed zones, and said system additionally comprising means which allow pivoting only in one or some planes, the number and orientation of which are defined.

17. The system of articulation as claimed in claim 16, wherein said pivot parts take the form of a ring, a loop, a hook or a polygonal plate, having a recess limited by an at least partially curved surface.

18. The system of articulation as claimed in claim 16, wherein the at least partially curved surface limiting the recessed zone of each of the pivot parts is circular.

19. The system of articulation as claimed in claim 16, wherein one at least of the ends of said rigid elements incorporates a receptacle, open on the articulation side and provided with a tie rod, one end of which is held captive in said receptacle and the other end of which constitutes one of said pivot parts, said elastic means cooperating with said tie rod in order to force the bearing faces of said rigid elements to remain in contact one with the other.

20. The system of articulation as claimed in claim 16, wherein one at least of the ends of said rigid elements incorporates a receptacle, open on the articulation side, and the wall of said receptacle has at least one axial notch, the geometry and size of which allow a pivot part portion to penetrate into said notch from the open end of said receptacle.

21. The system of articulation as claimed in claim 16, wherein an anti-rotation relief is provided on one of the pivot parts.

22. The system of articulation as claimed in claim 16, wherein an anti-rotation relief is provided on one of the pivot parts and said anti-rotation relief constitutes the pivot part portion capable of penetrating into the notch(es).

23. The system of articulation as claimed in claim 16, wherein
one at least of the ends of said rigid elements incorporates a receptacle, open on the articulation side, in that the wall of said receptacle has at least one axial notch, the geometry and size of which allow a pivot part portion to penetrate into said notch from the open end of said receptacle and
said wall has access ramps to said notch from the outside of the rigid element.

24. The system of articulation as claimed in claim 16, wherein:
one at least of the ends of said rigid elements incorporates a receptacle, open on the articulation side, the wall of said receptacle has at least one axial notch, the geometry and size of which allow a pivot part portion to penetrate into said notch from the open end of said receptacle and,
on the outer face of said wall and opposite the open end of the receptacle, said notch opens out into a concave (or convex) surface of revolution, and in that the end of the other rigid element comprises a convex (or concave) surface of revolution of complementary size and shape.

25. The system of articulation as claimed in claim 16, wherein said bearing faces have at least one pair of complementary reliefs suitable for engaging in a selected relative angular position of the two rigid elements.

26. The system of articulation as claimed in claim 16, wherein said rigid elements are respectively a spectacle side-piece and a spectacle face.

27. The system of articulation as claimed in claim 16, wherein one at least of the elements comprises, at its end opposite to the articulation (A), a joining means capable of engaging temporarily with a complementary joining means provided on another element.

28. The system of articulation as claimed in claim 16, wherein said rigid elements belong to an articulated train for use in robotics.
